(19) United States
(12) Patent Application Publication
(10) Pub. No.: US 2008/0258464 A1
(43) Pub. Date: Oct. 23, 2008

(54) Fitting for a tube

(75) Inventors: Bernd Kaufmann, Hassfurt (DE); Thomas Kern, Thungen (DE)

Correspondence Address: DILLER, RAMIK & WIGHT, 7345 MCWHORTER PLACE, SUITE 101, ANNANDALE, VA, 22003, US

(73) Assignee: Uponor Innovation AB, Fristad (SE)

(21) Appl. No.: 11/907,309

(22) Filed: Oct. 11, 2007

(30) Foreign Application Priority Data
Oct. 12, 2006 (DE) 10 2006 048 287.5

(51) Int. Cl. F16L 25/00

(52) U.S. Cl. 285/420

(57) ABSTRACT

A fitting tube including a fitting body (12) having a support sleeve (14) for connecting a tube thereto, a press sleeve (16) surrounding the support sleeve (14) and at least one holding element (18) for holding the press sleeve (16) to the fitting body (12). The holding element (18) engages a circumferential receiving groove (26) formed on the fitting body (12). The press sleeve (16) has at least two receiving openings (24) which, with the press sleeve (16) held to the fitting body (12), are arranged substantially in the radial plane defined by receiving groove (26). The holding element (18) includes two legs (22) which extend through the receiving openings (24) in order to hold the press sleeve (16) to the fitting body (12), and project in a circumferential direction into the receiving groove (26), and/or extend tangentially thereto through substantially diametrically opposite partial regions of the receiving groove (26).

### BACKGROUND OF THE INVENTION

The present invention relates to a fitting for a tube and particularly for a tube which on its inner side comprises plastic. Such a tube, for instance, can have a wall consisting of plastic throughout and having a one- or multi-layered structure. Alternatively, such a tube can consist of a plastic/metal compound material and thus comprise also a metallic layer.

Fittings for tubes with press sleeves are known in a wide variety of configurations. These fittings respectively comprise a fitting body provided with a support sleeve for mounting thereon the end of a tube to be connected. The support sleeve can be profiled on its outer side. Further, the support sleeve can be provided with one or a plurality of sealing rings. Further belonging to the fitting is a press sleeve surrounding the support sleeve at a distance and substantially concentrically therewith. When the press sleeve, which in the connected condition of the tube surrounds the connection end of the tube, is subjected to radial pressure, the connection end of the tube will be permanently pressed onto the support sleeve. Usually, press sleeves are made of plastically deformable material and particularly of metal.

Examples of fittings of the above mentioned type are found in DE 100 10 573 C1, DE 101 34 727 A1, DE 101 52 975 C1 and DE 102 33 559 B3. In these documents, reference is made to further documents describing further fittings of the above outlined type.

When a tube is to be mounted to a fitting, it is of advantage if the press sleeve is positioned on the fitting concentrically with the support sleeve and at a distance to the latter. Then, the mechanic merely has to shift the tube's connection end between the press sleeve and the support sleeve in order to then be able to perform the radial pressing process. In this process, the press sleeve is either held directly on the support sleeve or on the fitting body (cf. DE 100 10 573 C1 and DE 101 52 975 C1), or the fitting encloses a holding element for connecting the press sleeve to the fitting body and the support sleeve, respectively (cf. DE 101 34 727 A1 and DE 102 33 559 B3).

In known fittings with premounted press sleeve, the expenditure for the premounting process is not negligible. This applies particularly in case of tube fittings having a diameter larger than 40 mm because the fitting bodies must be given corresponding dimensions and thus also the holding elements or other configurations on the fitting body require a correspondingly large quantity of material.

It is an object of the invention to provide a fitting for a tube and particularly for a tube comprising plastic on its inner side wherein the fitting is provided with an improved holding mechanism for the press sleeve.

### SUMMARY OF THE INVENTION

In unison with the present invention, to achieve the above object, there is proposed a fitting for a tube, particularly for a tube comprising plastic on its inner side, said fitting comprising
a fitting body including a support sleeve adapted for mounting thereon a tube which is to be connected,
a press sleeve surrounding the support sleeve substantially concentrically and at a distance therefrom, and
at least one holding element for holding the press sleeve to the fitting body,
the holding element being configured to engage a circumferential receiving groove formed on the fitting body.

According to the present invention, it is provided, in a fitting of the above type, that
the press sleeve is formed with at least two receiving openings which, in the condition where the press sleeve is held to the fitting body, are arranged substantially in the radial plane defined by the receiving groove of the fitting body, and
the holding element comprises two legs projecting into the receiving groove to thus hold the press sleeve, wherein it is particularly provided that the legs at the fitting body extend through the receiving openings of the press sleeve and in the circumferential direction of the receiving groove of the fitting body and/or tangentially thereto through substantially diametrically opposite partial regions of the receiving groove.

The fitting of the invention serves for connecting a tube of the type described in the introduction to the specification. The fitting comprises a fitting body including a support sleeve and a press sleeve which by means of a holding element is fastened to the fitting body and to its support sleeve, respectively. In this condition, the holding element engages a receiving groove on the fitting body, which receiving groove extends around the fitting body and the support sleeve, respectively, in the circumferential direction.

According to the invention, the holding element extends in a radial, secantial or other direction through the press sleeve and through a part of the receiving groove of the fitting body. Thus, the holding element can project radially inwardly into the receiving groove, or it extends secantially or in a direction parallel or angular thereto through (a part of) the receiving groove. The holding element comprises two legs which are formed separately from each other or are connected to each other. In the simplest case, the legs are substantially straight pins extending through respectively one receiving opening of the press sleeve and into the receiving groove while being oriented radially, secantially or tangentially relative to the receiving groove. It can be provided that, on the side of the press sleeve wall opposite to the openings of the press sleeve, the legs or pins extend out of the press sleeve again through openings formed in this region. This, however, is not imperative.

The advantage of the inventive holding mechanism for the press sleeve resides in that, even in case of large nominal widths of the fittings, no projecting flanges need be provided on the fitting in order to hold the press sleeve. Particularly with fittings of large nominal widths, the quantity of material required for such configurations would not be negligible and would thus cause increased costs. As a further advantage, the invention obviates the need for a further processing performed on such configurations on the fitting for holding the press sleeve. According to the invention, it is merely required that the fitting body (e.g. in the region of its support sleeve or outside of this region) comprises a receiving groove extending in the circumferential direction. This receiving groove does not necessarily have to extend along the whole circumference.

It will suffice if the fitting body has a receiving groove or a receiving groove portion at least in those regions where the legs of the holding element extend. As a further advantage, the concept of the invention makes it possible to use the same holding element for a plurality of different nominal widths, provided that the holding element comprises resilient legs. Finally, it is of advantage that the mounting process for fixing is virtually as simple as conceivable, requiring no more than sliding the holding element laterally through receiving openings of the press sleeve into the latter and thus onto the fitting.

As already mentioned above, the two legs on both sides of the fitting body and the support sleeve, respectively, extend within substantially diametrically opposite regions where the receiving grooves or receiving groove portions are formed. Thus, the two receiving openings of the press sleeve are arranged preferably on two mutually parallel straight lines which in turn extend substantially tangentially to the receiving groove of the fitting body or substantially parallel to directions which are tangential with respect to the receiving groove of the fitting body.

It is suitable if each leg passes through two receiving openings of the press sleeve. In a manner similar to the two first receiving openings, also the two second receiving openings are arranged substantially in a (common) radial plane in which there are arranged also the receiving groove of the fitting body or the portions of the receiving groove of the fitting body which have the legs extending therethrough. Thus, the two legs are supported on two mutually spaced sites on the press sleeve (notably where the legs extend through the receiving openings of the press sleeve); thereby, increased stability is lent to the whole fixing structure and particularly to the attachment of the holding element to the press sleeve. In the region between the two openings, each leg can be immersed with the aid of spring force into the receiving groove of the fitting body and thus will reliably remain in this position, both during transportation and during the handling of the fitting in situ.

Preferably, the two legs are connected to each other via a base portion of the holding element. Thus, the two legs form a holding element which can be handled as one integral piece.

According to an advantageous embodiment of the invention, it is further provided that the two legs have a wavelike shape, wherein the wave shapes of the legs extend symmetrically to an axis (axis of symmetry) running in the direction of the diameter of the press sleeve, and in those regions of the legs which are received by the receiving groove of the fitting body on diametrically opposite circumferential portions, the legs are curved; preferably this curved shape follows the circumferential direction of the receiving groove. Thus, the holding element described herein has a shape similar to that of a hairpin.

As already explained above, the holding element, in order to be able to exert its holding function, does not necessarily have to project in the outward direction from the press sleeve. However, to facilitate the mounting process or for other reasons, the holding element can be arranged to project outward from the press sleeve. In this manner, particularly, the resultant projecting length of the holding element can be utilized as an abutment and for guidance when applying a press tool and during the press-on process. The abutment and guidance function can be carried out both by the free ends of the legs and by the base portion of the holding element forming the legs. For the abutment and guidance function, it is the base portion which is better suited because, by giving it a corresponding shape, this portion can be formed as an element extending around the press sleeve substantially by an angular range from 90° to 180° or some other angular range smaller than 180°. Further, the base portion can have a guiding element arranged thereon which extends around the press sleeve in the above described angular range. While the holding element is made e.g. of metal and particularly is formed as a specially curved metal wire, the guiding element can comprise plastic which—by injection molding technology—is molded as one integral piece with the holding element.

According to a further preferred embodiment of the invention, the base portion of the holding element and/or the guiding element is provided with at least one breakable or shearable projection which, when the press sleeve is being pressed on, can be broken off or sheared off from the holding element or the guiding element by means of the pressing tool. Thereby, a press-on indication is realized since the fact that the at least one projection has been broken or sheared off, will make it visually verifiable from the outside that the press fitting has been pressed into place. The at least one projection extends from the holding element or the guiding element in such a manner that it is arranged on the press sleeve in the region adjacent to the holding element or guiding element, in which region the pressing tool will be in abutment on the press sleeve during the press-on process.

Also alternative mechanisms for press-on indication can be provided. For instance, the base portion of the holding element and/or the guiding element can be connected to a detachable press-on indication element which, during the press-on of the press sleeve, can be detached from the base portion of the holding element and/or from the guiding element by means of the pressing tool. The base portion, the guiding element and the press-on indication element in combination can form a segmented ring extending along a circumferential sector and preferably along the whole circumference of the press sleeve around the same; these elements are initially in a mutually connected condition while, in the press-on process, this connection will be interrupted by the pressing tool. Thus, the press-on indication element will fall off from the base portion of the holding element and from the guiding element, respectively, thus visually indicating that a press-on condition has been established.

Preferred embodiments of the invention will be described in greater detail hereunder with reference to the accompanying drawings.

### BRIEF DESCRIPTION OF THE DRAWINGS

FIG. 1 is a perspective view of a fitting body, wherein a press sleeve is shown as held to the fitting body by a spring-clip-type holding element.

FIG. 2 is a perspective view of the press sleeve with a spring-clip-type holding element and without a fitting body.

FIG. 3 is an exploded view of the fitting of FIG. 1.

FIG. 4 is a view of the fitting similar to the view of FIG. 1, showing an alternative design of the holding element.

FIG. 5 is a view of a further embodiment of a fitting, showing an alternative design of the holding element as compared to FIGS. 1 and 4.

FIG. 6 is a view of a further embodiment of the holding element with press-on indication.

FIG. 7 is an axial view of the concentric press and support sleeves of a fitting including a spring-clip-type holding element for the press sleeve and provided with an alternative press-on indication.

FIG. 8 is an enlarged perspective view of a detail of the embodiment of a spring-clip-type holding element with press-on indication according to FIG. 7.

### DETAILED DESCRIPTION OF PREFERRED EMBODIMENTS

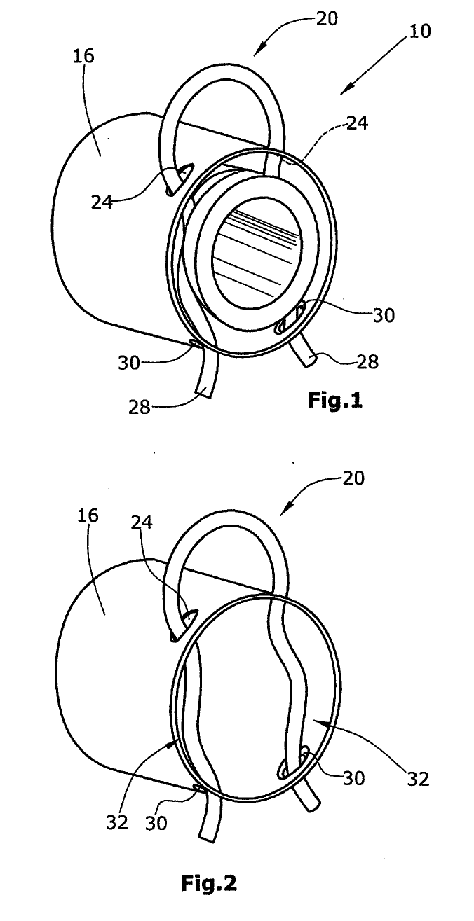

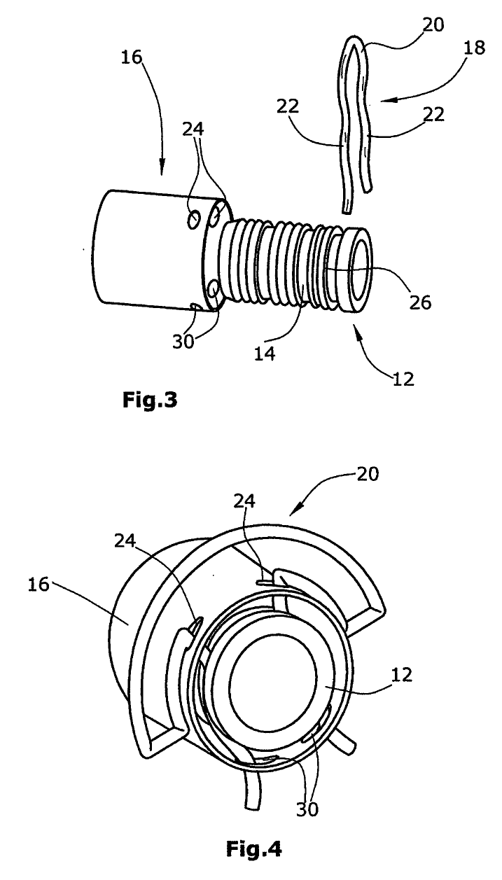

FIGS. 1 to 3 illustrate a first embodiment of a fitting 10. Fitting 10 comprises a fitting body 12 provided with a support sleeve 14. Apart from this support sleeve 14, the fitting body 12 can still comprise further components, such as e.g. a further support sleeve, or a thread as well as a tool engagement means for screwing the fitting tight by use of a tool. The Figures are largely restricted to that part of the fitting body 12 which is relevant for the invention, which will suffice for the description of the invention.

Arranged concentrically around support sleeve 14 is a press sleeve 16 which with the aid of a holding element 18 of the spring-clip-type is held to fitting body 12 and support sleeve 14, respectively. The holding element 18 comprises a spring wire having a bent shape as illustrated in the drawing and includes a central or base portion 20 and two legs 22. The legs 22 are guided through openings 24 of press sleeve 16 and, within a partial region internally of press sleeve 16, extend through a receiving groove 26 which is formed as a peripheral groove in the fitting body 12 and, in the present embodiment, in the support sleeve 14 of fitting body 12. The free ends 28 of the legs 22 facing away from the base portion 20 are guided out through two further openings 30 of press sleeve 16. In the present embodiment, the legs 22 have a wave-like shape, and in the circumferential dimension of support sleeve 14 the legs 22 comprises curved middle portions 32 within which the legs 22 are arranged in diametrically opposite portions of receiving groove 26. As illustrated, the two pairs of receiving openings 24 and 30 of press sleeve 16 are each arranged mutually opposite, wherein the two straight lines extending respectively through one of the receiving openings 24 and one of the receiving openings 30 are arranged on both sides of the support sleeve 14 or, in other words, the support sleeve 14 in the region of its receiving groove 26 is arranged between these two lines. With the aid of the holding element 18 formed as a spring clip that is provided to be advanced radially from the outside through the receiving openings of press sleeve 16 and thus onto support sleeve 14, the press sleeve 16 can be fixed on the support sleeve 14. The receiving openings 24 and 30 of press sleeve 16 will then be arranged substantially in the same radial plane in which also the circumferential receiving groove 26 of support sleeve 14 is arranged. In those regions of the legs 22 which are arranged between press sleeve 16 and support sleeve 14, the legs 22 also act as an abutment for an end of a tube (not shown) to be connected, which end is to be inserted into the annular space between press sleeve 16 and support sleeve 14.

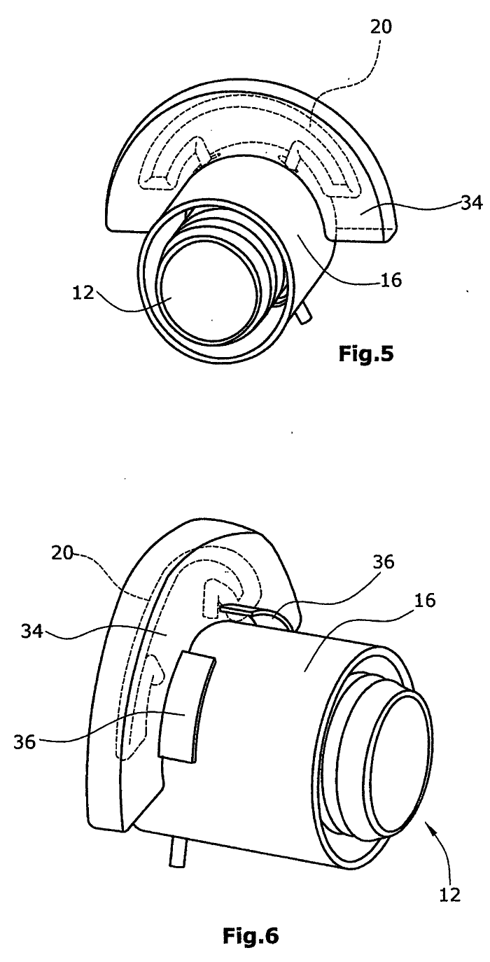

A further function is fulfilled by the base portion 20 of holding element 18. This base portion 20 radially extends from press sleeve 16 and thus, apart from its usefulness as a handle element during the mounting of the press sleeve 16 to the fitting body 12, is also suited for guiding and aligning a press tool when the latter is applied to the press sleeve 16. This function can still be enhanced by shaping the base portion 20 in the manner illustrated in FIGS. 4 and 5, for instance.

FIGS. 4 and 5 show two variants of the base portion 20 of the spring-clip-type holding element 18 according to FIGS. 1 to 3. Components of the fittings shown in FIGS. 4 and 5 which are identical or similar to those of the fitting 10 of FIGS. 1 to 3 are provided with the same reference numerals.

The alternative design of holding element 18 according to FIGS. 4 and 5 as compared to the holding element 18 according to FIGS. 1 to 3 pertains to the configuration of the base portions 20. As evident from FIGS. 4 and 5, the base portion 20 is drawn around the press sleeve 16 on the outside by about 180°, which is realized by a corresponding course of the wire of the spring-clip-type holding element 18, as illustrated in FIGS. 4 and 5.

In FIG. 5, it is further shown that the above described curved base portion 20 is surrounded by a semicircular plastic element functioning as a guide and abutment element 34. Thus, while in the embodiment according to FIG. 4 the guiding and abutment function for the press tool is realized by the wire in the base portion 20, this function is realized in the embodiment according to FIG. 5 by the provision the guide and abutment element 34.

Shown in FIG. 6 is a further embodiment of the guide and abutment element 34 of FIG. 5. In this embodiment, the element 34 has two press-on indication flaps 36 formed thereto which can also be made of plastic and are arranged at a radial distance from the press sleeve. In this arrangement, when the press jaws of the press tool are during the press-on process moved from the outside against the press sleeve 16 and will thus press against the press sleeve 16, the press-on indication flaps 36 will be broken or sheared off from the guide and abutment element 34 so that they will not exist anymore after the press-on process. This condition will then serve as an optical indicator evidencing a completed press-on process of fitting 10.

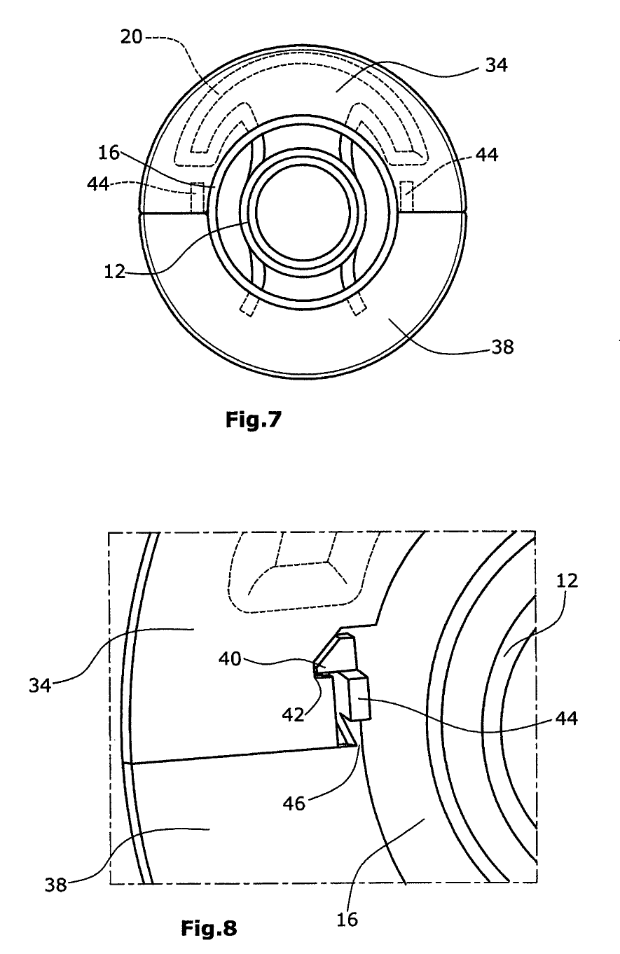

The last embodiment of the invention to be described here is illustrated in FIGS. 7 and 8. Attached to the guide and abutment element 34 in this embodiment is a second semicircular element 38 which again serves for press-on indication. This press-on indication element 38 is detachably connected to the guide and abutment element 34; in this embodiment, this connection is realized by hooks 40. The hooks 40 of the press-on indication element 38 are provided for engagement with undercut portions 42 formed on the inner side of guide and abutment element 34. Extending from the hooks 40 are projections 44 which are arranged diametrically opposite to each other and are positioned substantially at the level of the diameter of press sleeve 16. The hooks 40 are connected to the semicircular portion of press-on indication element 38 via predetermined break points 46. When the press sleeve 16 is being pressed on, the press tool acts on the projections 44 to the effect that the hooks 40 will be sheared off or broken off at their predetermined break points 46 and the press-on indication element 38 will fall off the fitting, thus visually indicating a completed press-on process.

To sum up, the advantages of the inventive sleeve attachment can be outlined as follows:
There is accomplished a sleeve attachment which does not necessitate additional abutment elements or sleeve attachment rings on the fitting body. Particularly in case of large diameters, such constructional elements would require more than a mere negligible quantity of material whereas, in the invention, this material can be saved. Further, under the aspect of production technology, the fitting body without the abutment elements or rings and resp. flanges for sleeve attachment can be produced in a less complex manner since, particularly, no undercuts will be required anymore on the outer side of the fitting body.
The invention is of use both for stainless steel sleeves and aluminum sleeves as well as for virtually all sleeves made of metal or plastic. The material of the fitting body can be selected independently and can particularly comprise metal or plastic (to be reinforced by fibers, if required).
In its regions extending between press sleeve and support sleeve, the holding element can function as a tube abutment, if desired.
That portion of the holding element which projects radially from the press sleeve can function as an abutment and guiding means for a press tool. In this region, the holding element can be provided with “simple plastic” molded therearound which can be kept in different colors, each of them assigned to a respective system or customer for visual identification. Also without this added plastic, however, a visual indication for identifying the system or customer could be performed e.g. by a varied coloring of the holding element.
Standardized press tools can be used further on without modification.
Adding the press-on indication elements to the holding element will result in a multifunctional component which can be used as a holding means for the press sleeve, as a tube abutment means, as a guiding means for the press tool and for press-on indication alike.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

What is claimed is:

1. A fitting for a tube, particularly for a tube comprising plastic on its inner side, said fitting comprising
a fitting body (12) including a support sleeve (14) adapted for mounting thereon a tube which is to be connected,
a press sleeve (16) surrounding the support sleeve (14) substantially concentrically and at a distance therefrom, and
at least one holding element (18) for holding the press sleeve (16) to the fitting body (12),
the holding element (18) being configured to engage a circumferential receiving groove (26) formed on the fitting body (12),
wherein
the press sleeve (16) is formed with at least two receiving openings (24) which, in the condition where the press sleeve (16) is held to the fitting body (12), are arranged substantially in the radial plane defined by the receiving groove (26) of the fitting body (12), and
the holding element (18) comprises two legs (22) extending through the receiving openings (24) of the press sleeve (16) to hold the press sleeve (16) to the fitting body (12), and projecting into the receiving groove (26).

2. The fitting according to claim 1 wherein the two legs (22) extend in the circumferential direction of the receiving groove (26) of the fitting body (12) and/or tangentially thereto through substantially diametrically opposite partial regions of the receiving groove (26).

3. The fitting according to claim 1 wherein the two receiving openings (24) of the press sleeve (16) are arranged on two mutually parallel straight lines extending substantially tangentially to the receiving groove (26) of the fitting body (12) or substantially parallel to directions tangential to the receiving groove (26) of the fitting body (12).

4. The fitting according to claim 1 wherein the press sleeve (16) comprises two further receiving openings (30) and each leg (22) of the holding element (18) extends through two opposite receiving openings (24,30) and in a region (32) between these receiving openings (24,30) extends through the receiving groove (26) of the fitting body (12).

5. The fitting according to claim 1 wherein the holding element (18) comprises a base portion (20) having the two legs (22) extending therefrom.

6. The fitting according to claim 1 wherein the two legs (22) have a wavelike shape, wherein the wave shapes of the legs (22) extend symmetrically to an axis oriented in the direction of the diameter of the press sleeve (16), and wherein, in those regions (32) of the legs which are received by the receiving groove (26) of the fitting body (12) on diametrically opposite circumferential portions, the legs are curved, preferably substantially in the circumferential direction of the receiving groove (26).

7. The fitting according to claim 1 wherein the receiving groove (26) of the fitting body (12) is formed in the support sleeve (14) of the fitting body (12).

8. The fitting according to claim 5 wherein, with the legs (22) extending through the receiving openings (24) of the press sleeve (16) and through the receiving groove (26) of the fitting body (12), the base portion (20) or the free ends of the legs (22) of the holding element (18) extend/extends from the press sleeve (16) while acting as a guiding abutment for a pressing tool used for pressing the press sleeve (16) into place.

9. The fitting according to claim 5 wherein, with the legs (22) extending through the receiving openings (24) of the press sleeve (16) and through the receiving groove (26) of the fitting body (12), the base portion (20) of the holding element (18) extends from the press sleeve (16) and wherein the base portion (20) of the holding element (18) is provided with a guiding element (34) providing a guiding abutment for a press tool.

10. The fitting according to claim 8 wherein the base portion (20) of the holding element (18) is formed to extend around the press sleeve (16) substantially by 90° to 180° and/or the guiding element (34) is formed to extend around the press sleeve (16) substantially by 90° to 180°.

11. The fitting according to claim 8 wherein, on the base portion (20) of the holding element (18) and/or on the guiding element (34), at least one projection (36) is arranged to be broken off by the pressing tool when the press sleeve (16) is being pressed on.

12. The fitting according to claim 8 wherein the base portion (20) of the holding element (18) and/or on the guiding element (34) are/is connected to a detachable press-on indication element (38) provided to be detached from the base portion (20) of the holding element (18) and/ or from the guiding element (34) by means of the pressing tool when the press sleeve (16) is being pressed on.
